(19) United States
(12) Patent Application Publication
(10) Pub. No.: US 2003/0115397 A1
(43) Pub. Date: Jun. 19, 2003

(54) Computer system with dedicated system management buses

(76) Inventors: Pete A. Hawkins, San Luis Obispo, CA (US); Kuriappan P. Alappat, Portland, OR (US)

Correspondence Address: KENYON & KENYON, 1500 K STREET, N.W., SUITE 700, WASHINGTON, DC, 20005, US

(21) Appl. No.: 10/014,904

(22) Filed: Dec. 14, 2001

(51) Int. Cl. G06F 13/14

(52) U.S. Cl. 710/305

(57) ABSTRACT

A system includes a central management agent and one or more field replaceable unit type specific management buses. Each field replaceable unit type specific management bus may couple the central management agent to a set of field replaceable units, with each unit in each set being the same type of field replaceable unit.

### FIELD OF THE INVENTION

Embodiments of the present invention relate to computer system management and maintenance. In particular, embodiments of the present invention relate to the arrangement of system management buses in a computer system with multiple types of field replaceable units.

### BACKGROUND

During the operating life of a computer system, various components in the computer system may malfunction. Such malfunctions may be the result of different stress factors that may be controlled. For example, high operating temperatures may be controlled by the use of a fan. Even when the stress on components is reduced, however, components still may malfunction and need to be replaced.

Some computer systems include system management features that may monitor and control the “health” of the system hardware. System management features may include the monitoring of elements such as system temperatures, voltages, fans, power supplies, bus errors, system physical security, etc. In addition, system management features may also include the determination of information that may help identify a failed hardware component, and may include the issuance of an alert specifying that a component has failed. Upon receipt of an alert, a repair technician may then travel to the computer system (if they are located offsite) and make the necessary repairs or component replacements. Through the use of such system management features, a level of manageability may be built-in to the platform hardware.

### DESCRIPTION OF THE DRAWINGS

FIG. 1 is a block diagram of a computer system with dedicated system management buses according to an embodiment of the present invention.

FIG. 2 is a flow diagram of a method of detecting a component failure in a computer system with dedicated system management buses according to an embodiment of the present invention.

FIG. 3 is a block diagram of another computer system with dedicated system management buses according to an embodiment of the present invention.

### DETAILED DESCRIPTION

The present invention discloses a computer system with system management features that has one or more separate system management buses that are dedicated to specific components types. Embodiments of the present invention contain a number of field replaceable units (FRUs), a central management agent, and a number of field replaceable unit type specific (“FRU-type-specific”) management buses that couple the central management agent to the field replaceable units. A field replaceable unit is a component that may be replaced in its entirety as part of a field service repair operation. According to the present invention, FRUs may be monitored by the system management features using the FRU-type-specific management buses.

In embodiments of the present invention, in addition to a central management agent, there is only one type of FRU coupled to each management bus. According to these embodiments, when a failure occurs that renders a particular management bus inoperable, the central management agent may determine that a certain type of FRU has likely failed based on the identity of the bus from which the failure indication has been received. In such a case, the central management agent may send an alert which may be received by a repair technician. Upon receipt of such a failure message, the repair technician may determine that the failure is either due to a failure in one or more of the FRUs of the certain type identified, in the central management agent, or in the particular management bus that was rendered inoperable. Thus, the technician may be deployed with only these FRUs, and the necessary inventories for replacement FRUs may be reduced. These and other embodiments will be described in more detail below.

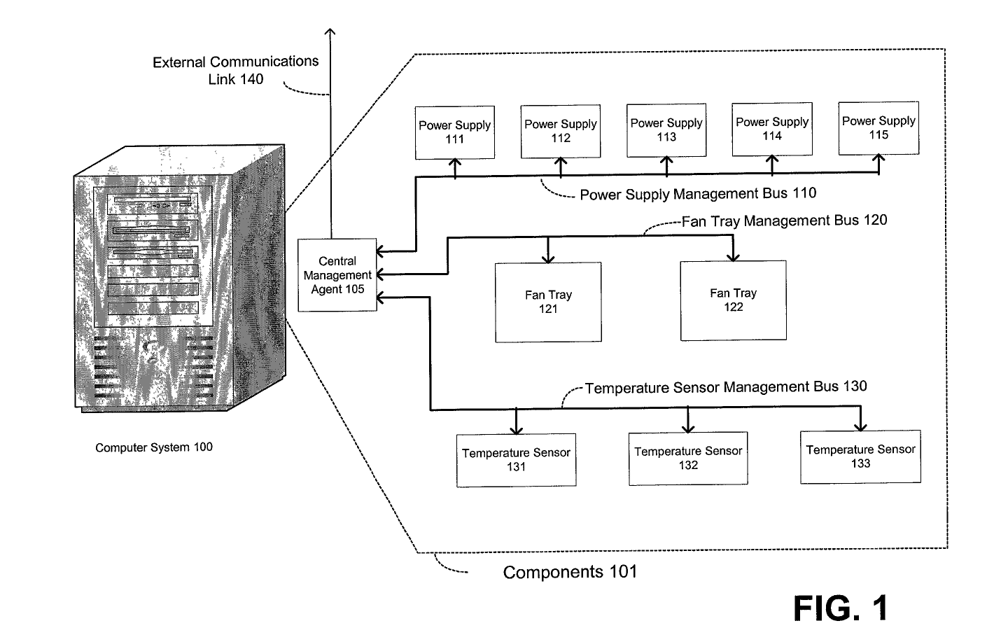

FIG. 1 is a block diagram of a computer system with dedicated system management buses according to an embodiment of the present invention. FIG. 1 shows a computer system 100 that has a plurality of components 101. The computer system may be any type of computer system with system management features. For example, computer system 100 may be a server, a client, a stand alone computer, a general purpose system, a dedicated system, a chassis containing one or more computing units, an application processor, a control processor, etc., or any combination of these. As shown in FIG. 1, the components in computer system 100 includes a central management agent 105 as well as a plurality of different types of FRUs and FRU-type-specific management buses. In particular, computer system 100 contains five power supplies (111-115), two fan trays (121-122), and three temperature sensors (131-133). The power supplies 111-115 are coupled to central management agent 105 by power supply management bus 110. The fan trays 121-122 are coupled to central management agent 105 by fan tray management bus 120. The temperature sensors 131-133 are coupled to central management agent 105 by temperature sensor management bus 130. The term coupled is intended to encompass elements that are directly connected or indirectly connected. For example, a bus couples two elements if a signal may be sent from one element to the other element through the bus whether or not the signal also passes through other connectors on route from one element to the other element.

Central management agent 105 may be any component that performs system management processing for computer system 100 or for a subset of the components in computer system 100. For example, central management agent 105 may monitor and/or control the power supplies 111-115, the fan trays 121-122, and the temperature sensors 131-133. Thus, central management agent 105 may determine that the temperature in a part of the system is too high, in which case central management agent 105 may send a signal to one of the fan trays 121-122 to increase fan speed. Central management agent 105 may also determine that one of the components in the system (e.g., power supply 111) is not working properly. Central management agent 105 may be a processor, micro-controller, application specific integrated circuit, etc. In embodiments, central management agent 105 processes instructions that are stored in a memory device such as a read only memory (ROM). Central management agent 105 may log information on system hardware in a memory device such as a flash memory, erasable programable read only memory (EPROM), etc.

Central management agent 105 maybe an FRU. Central management agent 105 may be a central management entity, such as an Intelligent Platform Management Interface (IPMI)-defined baseboard management controller (BMC) which communicates with other IPMI-defined IPMI controllers in the system. In embodiments, the central management agent 105 may collect management information from other FRUs, may monitor discrete sensors on it's own private management buses, may send alerts to a remote management user/system administrator, etc. Central management agent 105 may also be an abstracting agent, such as an IPMI controller, which may for example abstract information from non-intelligent temperature sensors throughout a chassis.

In an embodiment, central management agent 105 is coupled to an external communications link 140, which may be for example a modem that is coupled to a telephone line, a network card that is coupled to an Internet or a private network, etc. According to this embodiment, central management agent 105 may send information about the health of computer system 100 through external communications link 140 to a remote location such a network administrator. Such information may be sent on a regular basis and/or when an event occurs such as when a component failure is detected.

In the embodiment shown in FIG. 1, the management buses are specific to (i.e., dedicated to) any type of FRU. In other embodiments, the management buses may be specific to a type of interchangeable component. In such embodiments, each component of that type is interchangeable with any other component of that type. As shown in FIG. 1, power supply management bus 110, fan tray management bus 120, and temperature sensor management bus 130 are each FRU-type-specific management buses because they only couple one type of FRU to central management agent 105. Thus, other than one or more central management agents, the only type of FRU coupled to power supply management bus 110 is a power supply, the only type of FRU coupled to fan tray management bus 120 is a fan tray, and the only type of FRU coupled to temperature sensor management bus 130 is a temperature sensor. According to this arrangement, if a failure is detected on one of the type specific management buses, then central management agent 105 may determine that a type of FRU that has likely failed. In the case of a bus failure, the root cause may be any of the FRUs on the bus, which includes a central management agent, an FRU of the bus-dedicated type, or the bus itself. For example, if central management agent 105 determines that fan tray management bus 120 has become inoperable (e.g., because expected signals are not be received over fan tray management bus 120), then either the fan tray management bus 120, one of the fan trays 121-122, or the central management agent 105 has failed. A failure may also be indicated by, for example, a failure signal that is received over a management bus or the absence of a signal (e.g., a response) that was expected.

In an embodiment, central management agent 105 may send a signal over external communications link 140 indicating that a type of failure has been detected. In an embodiment, central management agent 105 relays information through external communications line 140 without performing any analysis. In another embodiment, central management agent 105 may perform analysis (e.g., verifying the information by looking for repeated failure occurrences) before sending information through external communications line 140. According to an embodiment, an FRU-type-specific management bus may be coupled to two or more redundant central management agents plus one or more FRUs of the same or interchangeable type.

The FRU-type-specific management buses in computer system 100 may be used to communicate management information between the central management agent 105 and one or more of the components in computer system 100. In embodiments, FRU-type-specific management buses in computer system 100 may be small (e.g., 2 lines), may be bi-directional, and/or may have a low bandwidth. The FRU-type-specific management buses may be any type of known management buses such as for example an Inter-IC bus (I²C) that conforms to the I²C Bus Specification developed by Philips Semiconductor Corp., a System Management Bus (SMBus) which conforms to the SMBus Specification of the SBS Implementers Forum, an Intelligent Platform Management Bus (IPMB) which conforms to the Intelligent Platform Management Bus Communications Protocol Specification, or an RS-485 bus which conforms to the RS-485 standard of the Electronic Industries Association (EIA) and the Telecommunications Industry Association (TIA). The FRU-type-specific management buses in computer system 100 may all be the same type of bus or one or more may be different types of buses.

In the embodiment shown in FIG. 1, power supplies 111-115 may be any power supplies that are interchangeable with each other, fan trays 121-122 may be any fan trays that are interchangeable, and temperature sensors 131-133 may be any temperature sensors that are interchangeable. Each of the FRUs are interchangeable with the other FRUs of this same type. For example, the power supply 111 may be used in place of power supply 112, which may be used in place of power supply 113, etc. In addition, the power supplies of a certain type may be replaced by another power supply of the same type. In an embodiment, the type of FRU (e.g., a power supply) may include any components having particular characteristics or a range of characteristics, such as the form factor, voltage uses, sensitivity, speed, etc. For example, the power supply type may be any power supply that provides at least a certain number of amperes of a certain voltage or a fan tray that provides at least a certain number of cubic feet per minute of air flow and fits in a certain space.

The power supplies, fan trays, and temperature sensors shown in FIG. 1 are examples of FRUs, and embodiments of the present invention may also contain any other types of FRUs such as boards, network switches, power entry modules, power filters, system status displays, etc. In other embodiments, the computer system may include any number of FRU types, and the computer system may have any number of each type of FRU.

In an embodiment, the removal of an individual FRU and/or management bus does not cause the computer system to stop operating and may not directly impact system availability. In an embodiment, computer system 100 has redundant components as a back-up in case of failure. For example, computer system 100 may not need five power supplies to operate (e.g., it may only need three power supplies), and thus the failure of one power supply such as power supply 111 will not cause an interruption in system operation. In this example, a repair technician may be able to replace power supply 111 with another power supply of the same type before any other power supplies fail, thus ensuring that there is no break in system operation. Such continuous operation is of particular concern in, for example, enterprise-class and high-availability systems.

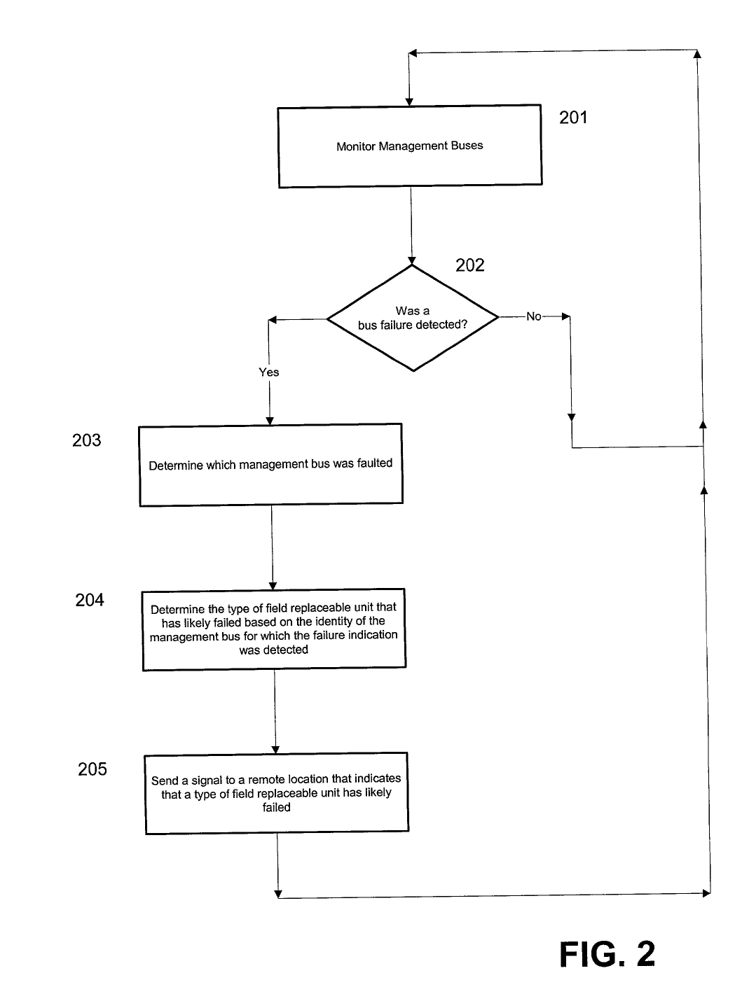

FIG. 2 is a flow diagram of a method of detecting a component failure in a computer system with dedicated system management buses according to an embodiment of the present invention. FIG. 2 is described with reference to the embodiment shown in FIG. 1, but of course this method may also be used with other embodiments. As shown in FIG. 2, a central management agent (e.g., central management agent 105) monitors management buses (e.g., buses 110, 120, and 130) to determine if there have been any failures (201). The central management agent may continue monitoring the buses, logging information, and/or controlling management features as long as a bus failure is not detected (202). If a bus failure is detected (202), the central management agent may determine which management bus is faulted (203). The central management agent may determine the type of FRU that has likely failed based on the identity of the management bus for which the failure indication was detected (204). For example, if central management agent 105 finds that the fan tray bus 120 is inoperable (e.g., a response is not received to a query), central management agent 105 may determine that either one of the fan trays may have failed, the fan tray bus 120 has failed, or the central management agent itself has failed. The central management agent may then send a signal to a remote location that indicates the type of FRU (e.g., fan tray) as the likely cause of the failure (205). As noted above, a technician who receives such a signal may conclude before leaving for the service call that there has been a failure in either the specified FRU type (e.g., a fan tray), the corresponding FRU-type-specific management bus (e.g., fan tray management bus 120), or the central management agent, and thus the service technician need not bring a fall inventory of all system components on the service call. In the embodiment shown in FIG. 2, after sending a signal to a remote location, the central management agent may continue to monitor the management buses, for example, to take corrective action (e.g., attempt to increase the speed of the other fans) and to determine if there are any other failures.

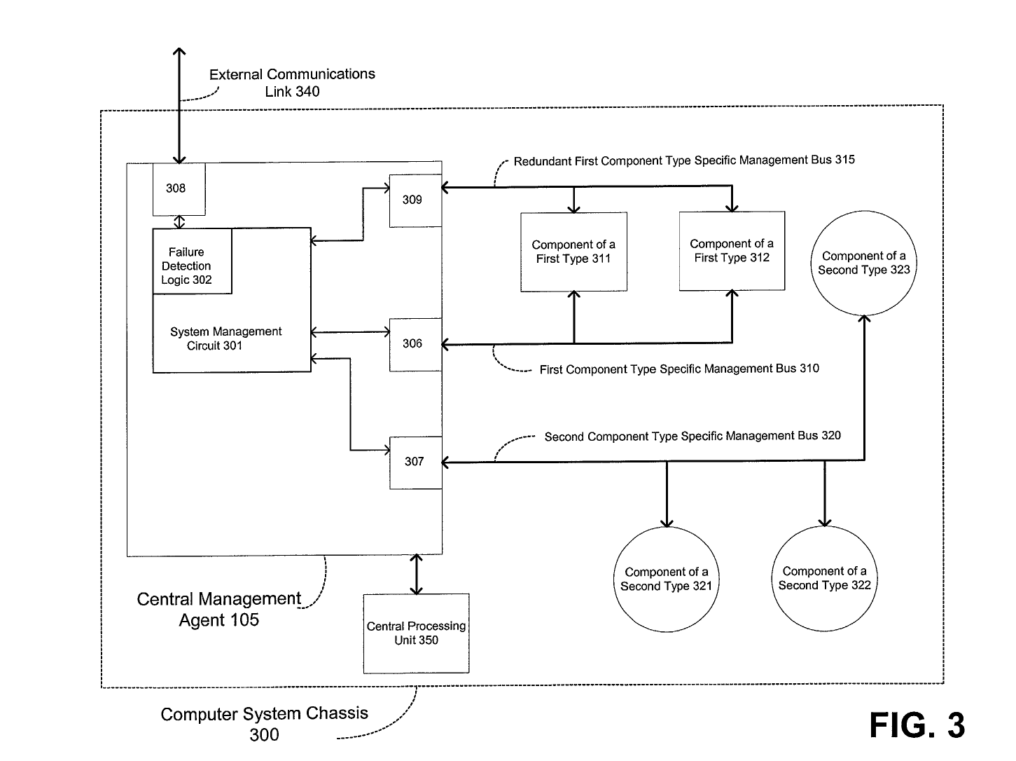

FIG. 3 is a block diagram of another computer system with dedicated system management buses according to an embodiment of the present invention. FIG. 3 shows a computer system chassis 300 that is the chassis for a computer system. Components within computer system chassis 300 include a central management agent 105, a set of two components of a first type 311-312, a set of three components of a second type 321-323, and a central processing unit 350. The central management agent 105 may be the same as central management agent 105 of FIG. 1. The components of a first type 311-312 and components of a second type 321-323 may be any type of components such as, for example, the FRUs that are shown in FIG. 1 and/or are listed above. The components of a first type 311-312 and components of a second type 321-323 may also be other types of components. The components of a first type 311-312 are all the same type of component and are all interchangeable with each other, and the components of a second type 321-323 are all the same type of component and are all interchangeable with each other. The components of a first type 311-312 are coupled to central management agent 105 by first component type specific management bus 310 and by redundant first component type specific management bus 315. Redundant first component type specific management bus 315 may perform the same function as first component type specific management bus 310 and may be a backup to first component type specific management bus 310 in the event that first component type specific management bus 310 becomes inoperable. In embodiments, there are redundant management buses for some or all of the management busses. Note that first component type specific management bus 310 and redundant first component type specific management bus 315 are not coupled to any components other than the central management agent 105 and the components of a first type. The components of a second type 321-323 are coupled to central management agent 105 by second component type specific management bus 320. Second component type specific management bus 320 is not coupled to any components other than the central management agent 105 and the components of a second type.

FIG. 3 shows that the central processing unit 350 is coupled to central management agent 105. In an embodiment, the central management agent 105 monitors (e.g., detects failures in, etc.) the central processing unit 350. In embodiments, the central management agent 105 communicates management information to the central processing unit 350, and in further embodiments the central processing unit sends the management information to a remote location. An external link 340 is coupled to central management agent 105, which maybe the same as external link 140 of FIG. 1.

As shown in FIG. 3, central management agent 105 contains a system management circuit 301 that is coupled to each of a first component type management bus interface 306, redundant first component type management bus interface 309, second component type management bus interface 307, and external communications interface 308. First component type management bus interface 306 may be a socket and/or logic that is used to connect the central management agent 105 and the first component type specific management bus to communicate management information, and second component type management bus interface 307 may be a socket and/or logic that is used to connect the central management agent 105 and the second component type specific management bus to communicate management information. System management circuit 301 contains failure detection logic 302. In an embodiment, failure detection logic 302 may determine that there has been a failure in a specific component type (e.g., based upon a determination that the corresponding management bus is inoperable). Failure detection logic 302 may be hardware, software, firmware, etc. In other embodiments, computer system chassis 300 may contain additional component type specific management buses, and central management agent 105 may contain additional component type specific management bus interfaces. The system may also contain other buses (not shown) in addition to the management buses, such as data buses and address buses. In addition, the system may also contain redundant central management agents as discussed above.

Several embodiments of the present invention are specifically illustrated and/or described herein. However, it will be appreciated that modifications and variations of the present invention are covered by the above teachings and within the purview of the appended claims without departing from the spirit and intended scope of the invention. For example, although the disclosed embodiments only show component type specific management buses, the present invention may be implemented in a system that has both type specific management buses and non-type specific management buses.

What is claimed is:

1. A system comprising:
a central management agent; and
a field replaceable unit type specific management bus coupled to the central management agent.

2. The system of claim 1, wherein the system further comprises a plurality of field replaceable units of a first type which are coupled to the central management agent by said field replaceable unit type specific management bus.

3. The system of claim 2, wherein the system further comprises:
second field replaceable unit type specific management bus; and
a second plurality of field replaceable units of a second type which are coupled to the central management agent by said second field replaceable unit type specific management bus.

4. The system of claim 3, wherein said field replaceable unit type specific management buses are Inter-IC buses.

5. The system of claim 1, wherein the system further comprises a second central management agent coupled to one of the field replaceable unit type specific management buses.

6. A system comprising:
a central management agent;
a plurality of field replaceable units of a first type;
a first management bus coupling the central management agent to only the first type of field replaceable unit;
a plurality of field replaceable units of a second type; and
a second management bus coupling the central management agent to only the second type of field replaceable unit.

7. The system of claim 6, wherein the central management agent is a processor.

8. The system of claim 6, wherein the plurality of field replaceable units of a first type are temperature sensors and the plurality of field replaceable units of a second type are power supplies.

9. The system of claim 6, further comprising:
a plurality of a third type of field replaceable unit; and
a third management bus coupling the central management agent to only the third type of field replaceable unit.

10. The system of claim 9, wherein the plurality of field replaceable units of a third type are fan trays.

11. The system of claim 6, further comprising a second central management agent coupled to the first field replaceable unit type specific management bus and coupled to the second field replaceable unit type specific management bus.

12. A central management agent comprising:
a system management circuit;
a first management bus interface coupled to the system management circuit to communicate management information with only a first type of field replaceable unit; and
a second management bus interface coupled to the system management circuit to communicate management information with only a second type of field replaceable unit.

13. The central management agent of claim 12, wherein the system management circuit contains logic to determine that there has been a likely failure in a field replaceable unit of the first type based upon a determination that said first management bus is inoperable.

14. The central management agent of claim 13, wherein the central management agent further comprises an interface coupled to the system management circuit to communicate with a remote location.

15. The central management agent of claim 14, wherein the central management agent further comprises a third interface coupled to the processor to communicate management information to only a third type of field replaceable unit.

16. A system comprising:
a chassis;
a first plurality of interchangeable components located within said chassis;
a second plurality of interchangeable components located within said chassis;
a central management agent located within said chassis;
a first management bus coupled to the central management agent and coupled to each of the first plurality of interchangeable components, wherein the first management bus is not coupled to any other components; and
a second management bus coupled to the central management agent and coupled to each of the second plurality of interchangeable components, wherein the second management bus is not coupled to any other components.

17. The system of claim 16, wherein the system further comprises a central processing unit coupled to the central management agent.

18. The system of claim 17, wherein the first plurality of interchangeable components are power supplies.

19. The system of claim 18, wherein the second plurality of interchangeable components are fan trays.

20. The system of claim 19, wherein the central management agent is coupled to an external communication link.

21. The system of claim 17, wherein the system further comprises a second central management agent coupled to the first management bus, to the second management bus, and to the central management agent.

22. The system of claim 16, wherein the system further comprises a redundant first management bus coupled to the central management agent and coupled to each of the first plurality of interchangeable components, wherein the first management bus is not coupled to any other components.

23. A method of detecting a component failure in a computer system, the method comprising:
detecting a failure indication at a central management agent for a first of a plurality of management buses; and
determining that a type of field replaceable units has likely failed based on the identity of said first management bus.

24. The method of claim 23, wherein said failure indication is the absence of an expected signal from said first management bus.

25. The method of claim 23, wherein the method further comprises sending a signal from said central management agent to a remote location that indicates the type of field replaceable unit that has likely failed.

26. The method of claim 23, wherein the method further comprises:
detecting a failure indication at the central management agent from a second one of said plurality of management buses in the computer system; and
determining that a second type of field replaceable unit has likely failed based on the identify of said second management bus.

27. A system comprising:
a central management agent;
a first set of components of a first type, wherein each of the components in said first set is interchangeable with the other components in said first set;
a first management bus that is coupled to the central management agent and to the first set of components and that is dedicated to the first set of components;
a second set of components of a second type, wherein each of the components in said second set is interchangeable with the other components in said second set but is not interchangeable with the components in said first set; and
a second management bus that is coupled to the central management agent and to the second set of components and that is dedicated to the second set of components.

28. The system of claim 27, wherein the central management agent is adapted to manage the hardware in a subsystem in a computer system.

29. The system of claim 27, wherein the central management agent is an abstracting agent.

30. The system of claim 27, further comprising a third management bus that is coupled to the central management agent and to the first set of components and that is dedicated to the first set of components.
